(19) United States
(12) Patent Application Publication
(10) Pub. No.: US 2018/0218561 A1
(43) Pub. Date: Aug. 2, 2018

(54) A SYSTEM AND METHOD FOR AUTOMATED VENDING OF TICKETS USING MULTIPLE INDIVIDUAL TICKET VENDING MACHINES IN A SHARED PHYSICAL LOCATION

(71) Applicant: Parkeon Transit Limited, Poole Dorset (GB)

(72) Inventors: Philip Oldroyd, Poole Dorset (GB); James Dickinson, Poole Dorset (GB)

(73) Assignee: Parkeon Transit Limited, Poole Dorset (GB)

(21) Appl. No.: 15/748,436

(22) PCT Filed: Jul. 26, 2016
(86) PCT No.: PCT/GB2016/052284

§ 371 Date: Jan. 29, 2018

(30) Foreign Application Priority Data
Jul. 29, 2015 (GB) 1513326.7
Sep. 11, 2015 (GB) 1516105.2

(51) Int. Cl. G07F 9/02; G07F 17/42; G07F 11/00; G06Q 20/18

(52) U.S. Cl. CPC G07F 9/023; G06Q 20/18; G07F 11/002; G07F 17/42

(57) ABSTRACT

An automated ticket vending system comprises multiple individual ticket vending machines in a shared physical location, a control system, and a communications facility for supporting communications between the individual ticket vending machines and the control system. Each ticket vending machine is configured to acquire data relating to the current level of usage of that ticket vending machine, and to transmit the acquired usage data to the control system. The control system is configured to receive and analyse the usage data from the multiple ticket vending machines, and responsive to such analysis of the usage data, transmit control instructions to the multiple individual ticket vending machines specifying appropriate actions to address the current level of usage of the multiple individual ticket vending machines within the automated ticket vending system as a whole. Each ticket vending machine is configured to perform the actions specified in the control instructions received from the control system.

### FIELD OF THE INVENTION

The present invention relates an automated ticket vending system and method which utilise multiple individual ticket vending machines in a shared physical location.

### BACKGROUND OF THE INVENTION

Ticket vending machines are used in public locations such as stations, car parks, hotels, cinemas, etc. for selling tickets and other closely related items. Such a ticket vending machine may include a touchscreen to allow a user to interact with the machine. It can be desirable to display information on the touchscreen even if no user is currently interacting with the machine—for example, displaying advertising or information about available tickets. This information may be displayed most effectively on larger screens, for example so as to be more visible to users further away from the ticket vending machine.

In many locations, the need for tickets may exceed the practical utilisation rate of a single ticket vending machine. For example, at large transport hubs, such as train stations, bus stations and airports, there is often a large demand for ticketing transactions. In such locations, it is common for multiple ticket vending machines to be installed to cope with this greater workload, which may be subject to considerable variation, such as between peak and off-peak travel times. However, there are usually constraints on the number of additional ticket vending machines that can be provided—both from an economic perspective (cost), and also because of practical issues, such as a lack of available physical space for the machines. Accordingly, it is important that multiple ticket vending machines can be used in an efficient manner so as to help minimise the number of additional ticket vending machines required for a given location.

Many existing ticket vending machines have a touch-screen at an inclined angle for ease of visibility and touch operation. However, having a vertical screen can make is easier for the ticket vending machine to accommodate a larger screen, and may also improve visibility of displayed information at a greater distance from the ticket vending machine. On the other hand, having such a vertical and larger screen should not compromise the usability and ergonomics of the ticket vending machine for its core purpose, namely as a machine for selling tickets.

### SUMMARY OF THE INVENTION

The invention is defined in the appended claims.

An automated ticket vending system comprises multiple individual ticket vending machines in a shared physical location, a control system, and a communications facility for supporting communications between the individual ticket vending machines and the control unit. Each ticket vending machine is configured to acquire data relating to the current level of usage of that ticket vending machine, and to transmit the acquired usage data to the control system. The control system is configured to receive and analyse the usage data from the multiple ticket vending machines, and responsive to such analysis of the usage data, transmit control instructions to the multiple individual ticket vending machines specifying appropriate actions to address the current level of usage of the multiple individual ticket vending machines within the automated ticket vending system as a whole. For example, the control system may send one or more instructions to one or more of the ticket vending machines, depending upon the action or actions (or no action) to be performed by each ticket vending machine. Each ticket vending machine is configured to perform the actions specified in the control instruction(s) received from the control system.

Also provided are a method of operating such an automated ticket vending system, and also multiple individual ticket vending machines and a control system for use in such an automated ticket vending system.

In such systems, the current usage data may be based on information such as the rate of transactions performed at the ticket vending machine, the number of people queuing at the ticket vending machine, and so on. A control instruction may specify a change in operating mode of the ticket vending machine (such as some modification in how it interacts with a user) and/or some information to be displayed by the ticket vending machine.

By operating the multiple ticket vending machines as a combined system such as described herein, the control system is able to acquire a better understanding of the current operational status of the overall system, and also has greater flexibility in terms of taking actions such as to address periods of high usage.

Also provided is a ticket vending machine which includes: a vertical touchscreen; a sensor system for acquiring information about a user; and a control system configured to define an active portion within the vertical touchscreen, wherein the user is able to interact with the vertical touchscreen by touching the active portion; and wherein the control system is further configured to set the height of the active portion within the vertical touchscreen according to the height of the user as derived from the information acquired by the sensor system about the user.

Positioning the active portion of a touchscreen according to an estimated height of a user, as derived from the information acquired by the sensor system, allows display information and interaction targets (e.g. buttons to be pressed/touched) to be positioned appropriately for each user—both in terms of good visibility and also in terms of convenient and comfortable touch operation. This facilitates the touchscreen having a vertical orientation, and so helps to provide a powerful display platform, which in turn allows more flexible use of the ticket vending machine, as well as providing a bespoke interaction experience for each user.

The ticket vending machine may allow the user to manually adjust the height of the active portion of the vertical touchscreen, for example, to change the automatic height setting as determined by the machine based on the information acquired by the sensor system. This allows the user to position the height of the active portion of the vertical touchscreen at a preferred height, especially if the height positioning provided by the machine itself is less effective—e.g. because there are multiple users together in front of the ticket vending machine, and the height setting of the active portion does not correspond to the height of the person who is actually going to perform the vending transaction.

The ticket vending machine may detect whether or not a person is approaching the ticket vending machine. This then provides an indication of whether the person is likely to want to use the machine (and may serve as a trigger for then starting to sense information that could be used for the height adjustment).

The sensor system may comprise an infrared sensor system, an imaging system, or any other appropriate facility. The sensor system may provide a three-dimensional detection field, which can help to provide better height estimates, e.g. by discriminating between shorter people who are nearby and taller people who are further away.

In some embodiments, the information acquired includes the number of users in the vicinity of the machine, for example by performing a face detection analysis. If multiple people appear to be queueing to use the machine, the control system may adjust the mode of operation of the ticket vending machine to try to enhance the throughput of customers, such as by speeding transitions between screens, etc.

### BRIEF DESCRIPTION OF THE DRAWINGS

Various embodiments of the invention will now be described in detail by way of example only with reference to the following drawings:

FIG. 1 is a schematic diagram of a ticket vending machine in accordance with some embodiments of the invention.

FIG. 2 is a schematic diagram of a vertical touchscreen of a ticket vending machine such as shown in FIG. 1.

FIG. 3 is a schematic diagram of a vertical touchscreen of a ticket vending machine such as shown in FIG. 1.

FIG. 4 is a schematic diagram of a vertical touchscreen of a ticket vending machine such as shown in FIG. 1.

FIG. 5 illustrates certain software components for a ticket vending machine such as shown in FIG. 1 in accordance with some embodiments.

FIG. 6 is a flow diagram of a method for adjusting the height of an active portion of a vertical touchscreen on a ticket vending machine such as shown in FIG. 1 in accordance with some embodiments.

FIG. 7 is a schematic diagram of a pair of ticket vending machines such as shown in FIG. 1.

FIG. 8 is a schematic diagram of a system in accordance with some embodiments of the invention comprising a set of multiple individual ticket vending machines.

### DETAILED DESCRIPTION

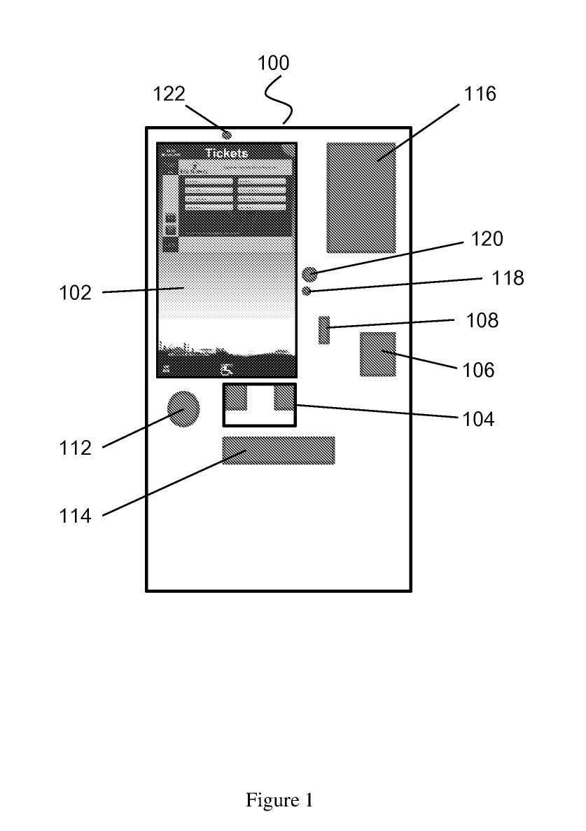

FIG. 1 illustrates a ticket vending machine 100 in accordance with some embodiments of the invention. The ticket vending machine comprises a vertical touchscreen 102, a sensor system 104 and a control system located internally within the machine (and hence not visible in FIG. 1). The control system may be based, for example, on a personal computer system or similar, running the Microsoft Windows operating system or any similar software platform such as Linux. The ticket vending machine may also comprise other standard components for generating tickets and facilitating ticket vending transactions. For example, the ticket vending machine may also comprise one or more of a card payment machine 106, a coin payment slot 108 and return tray 114, a contactless or NFC card reader 112, a ticket printer (again located internally within the machine, and hence not visible in FIG. 1) and a ticket collection tray 114. The ticket vending machine 100 is also provided with one or more data communication facilities (not shown in FIG. 1), as described in more detail below.

The tickets sold by the ticket vending machine 100 may be for a wide range of purposes, for example, tickets for a form of transport, such as train, tram, bus, ferry or other forms of public transport, tickets for parking or for any other type of tickets, such as cinemas and sporting events. The ticket vending machine 100 may sell tickets for just a single purpose, or for different or multiple purposes. For example, a ticket vending machine 100 may sell both rail travel tickets and parking tickets.

The ticket vending machine 100 may offer multiple different types of tickets, including dispensing physical tickets, such as printed paper tickets and/or contactless smartcard tickets, and/or some form of digital (non-physical) ticket, such as mobile payment and digital wallet tickets. The tickets may relate to individual items (journeys, shows, etc.), or may instead represent some form of (pre)payment card or facility, e.g. which can be used to pay for future train or bus trips within appropriate limits of time, geography and/or cost. The ticket vending machine may also be used to make on-line reservations, and so on.

The ticket vending machine 100 is intended to be sited and used in a public or shared space, such as a port or airport, train or bus station, shopping centre, theatre foyer, hotel lobby, car park, place of employment, etc. The ticket vending machine 100 is available for use by a wide range of people who pass through or into the public or shared space in which the machine is located. It is therefore important that vending machine 100 is designed to cope with a variety of potential users, e.g. regular commuters who might be very familiar with the operation of the ticket vending machine, and occasional travellers, perhaps from abroad, who do not have any familiarity with the machine.

The ticket vending machine 100 may be located proximate to the service for which the tickets sold are to be used, for example in a train or bus station where the tickets are to be used on public transport. Similarly, the ticket vending machine 100 may be located in a shopping mall where the tickets are to be used for parking. Alternatively, the ticket vending machine 100 may be located away from the service for which the tickets are to be used. For example, a ticket vending machine 100 to sell theatre tickets in London might be located at a railway station which provides train routes to London, thereby helping people to buy tickets in advance and avoiding them having to queue for the tickets in London itself. As mentioned above, some ticket vending machines may be able to provide multiple services—e.g. in the above example, a given machine in a railway station may be able to sell both tickets for rail services, and also tickets for the theatre and/or other such activities at the destination of the traveller.

The ticket vending machine includes a vertical touchscreen 102 to provide to display information to the user of the ticket vending machine 100 and to receive touch input from a user of the ticket vending machine. Vertical refers to the mounting of the touchscreen such that the plane or surface of the screen includes a substantially vertical axis. The touchscreen 102 may have a landscape or portrait configuration (for example), whilst still being mounted in the vertical configuration. The vertical touchscreen 102 may in practice not be exactly vertical, but will usually be offset by no more than 5 degrees, more commonly by no more than 2 degrees, and often by no more than 1 degree from the true vertical.

The vertical touchscreen may be relatively big, for example, extending by 0.6 m or more in the vertical direction, 0.8 m or more in the vertical direction, or over 1 m in the vertical direction. This is a large screen size compared with many existing ticket vending machines, and offers a considerable area for providing information to a user or to passers-by, whether instructions, maps, advertising, slogans, public information, artwork, etc. In some cases, a plurality of vertical touchscreens 102 may be provided to create an image wall, for example to increase the overall height and/or width of the display.

The vertical touchscreen 102 may be polarised or coated in a polymerisation film to allow the information displayed on the vertical touchscreen 102 to be seen only when viewed from a particular angle. For example, the vertical touchscreen 102 may be polarised or coated in a polymerisation film to prevent people standing alongside (rather than in front of) the ticket vending machine 100 from seeing the information displayed on the screen, such as when a number of ticket vending machines 100 are arranged side-by-side in a row.

The ticket vending machine 100 may comprise a second screen 116 which may be used to display a video call or similar interaction between a user at the ticket vending machine and an external assistant remotely located at a help centre or similar. The ticket vending machine 100 may also comprise a microphone 118, speaker 120, and/or webcam 122 to enable voice and video communications between the user and such an external assistant.

The locations of the various components of the vending machine 100 are presented in FIG. 1 by way of example only and it will be appreciated that these may be varied as appropriate depending upon the requirements of any given installation. Similarly, it will be appreciated that different components may be present in any given vending machine, again depending upon the particular requirements of any given installation.

The use of a vertical touchscreen 102 typically provides a greater display area for information than can be achieved with screens that have an inclined or sloped configuration. In particular, an inclined screen is limited in size (in practice) because such an inclined screen extends not only upwards but also inwards into the machine, and hence occupies depth as well as height. On the other hand, a user is able to look downwards onto such an inclined screen. This makes such a screen more easily usable by people of varying heights, in that taller people can still look down onto the inclined screen, even though it is slightly further from their eyes than for shorter people. However, this facility is not shared by a vertical touchscreen, in that if information is displayed to users at a different height from their eye level, then not only is such information further away, but it is also seen in a fore-shortened (distorted) manner.

Accordingly, the ticket vending machine 100 includes sensor system 104, which is configured to detect a (potential) user near the ticket vending machine 100. The sensor system 104 is also configured to acquire information about the user of the ticket vending machine (when detected). For example, the sensor system 104 may comprise motion sensing apparatus to detect the motion of a person near the ticket vending machine, e.g. within 6 or 10 metres of the ticket vending machine. The sensor system 104 may utilise infrared, optical, radio or other waves (or a combination of such techniques) to detect the presence of, and other relevant information about, a person near the ticket vending machine.

In some implementations, the sensor system 104 may comprise an infrared projector and camera configured to provide a three-dimensional scanning system. This enables volumetric scanning of the region around the ticket vending machine to detect the size of an object as well the distance the object is away from the sensor system 104.

In some implementations, the sensor system 104 comprises a commercially available unit, for example the Microsoft Kinect™ system from Microsoft Corporation, along with appropriate software for controlling the unit. For details about this system can be found at https://www.microsoft.com/en-us/kinectforwindows/ and in “Kinect for Windows: Human Interface Guidelines v2.0”, 2014, available from Microsoft Corporation.

The sensor system 104 may use a wireless communication technology, such as Bluetooth, Bluetooth Low Energy (BTLE) or Wi-Fi, to detect the presence of a mobile phone or personal electronic device near the ticket vending machine. The sensor system 104 may be configured to detect whether the mobile phone or personal electronic device has a ticketing application installed which is compatible with the ticket vending machine 100. If so, such an application may facilitate further interaction between the user and the ticket vending machine 100.

The sensor system 104 generally detects people within a certain range of the ticket vending machine 100 and/or within a certain viewing angle from the ticket vending machine. For example, the sensor system 104 may be configured to only detect people within say 3, 5 or 8 metres of the ticket vending machine 100. Similarly, if multiple ticket vending machines 100 are located next to or near one other, the sensor system 104 of a given ticket vending machine 100 may be configured to detect only people within a given range and/or direction of the ticket vending machine 100—in essence, those who are directly in front of this particular ticket vending machine. This prevents multiple ticket vending machines 100 from detecting the same person as they approach one of a group of ticket vending machines 100.

There are various ways in which the sensor system 104 may be constrained to only detect people only within a given range or position/angle relative to the ticket vending machine 100. For example, the sensing mechanism may be limited in aperture or viewing angle, so that it can only receive input from a limited range of positions. Alternatively (or additionally), the software associated with the sensor system 104 may be configured to discard from the detection process certain portions of the field of view of the camera and/or certain depths (or to discard any identification of people found within such portions of the field of view).

The information acquired by the sensor system 104 may be used to derive additional information about the user, either by the sensor system 104 itself, and/or by the control system. For example properties such as height, age range and gender may be derived from the information acquired by the sensor system 104. Facial detection or recognition may also be utilised to determine the presence of a user and/or the direction that the user is facing relative to the ticket vending machine 100. For example, it may be determined whether a user is walking towards the ticket vending machine 100, away from the ticket vending machine, or abeam the ticket vending machine. Facial detection/recognition may also be utilised to identify a number of features on the face of the user, such as eyes, ears, mouth, nose and chin. Facial recognition may further be utilised to determine the mood of the user, for example whether the user is smiling, frowning or crying. Such information may impact how the machine interacts with the user. Similarly, information acquired by the sensor system 104 may be used to determine the location of various parts of the user, for example their shoulders, arms, torso and legs.

The information acquired by the sensor system 104 may also be used to determine the number of users near the ticket vending machine, e.g. based on facial detection. More particular, the vending machine may be able to determine whether there is one current user of the ticket vending machine 100, or multiple such users, or whether there are several people waiting to use the ticket vending machine 100.

The additional derived information may be used to tailor or personalise the user experience of the ticket vending machine 100. For example, if multiple users are detected as being present, the system may provide information on group discounts, etc., or if a queue of users is detected, the system may progress through a script more quickly and/or omit optional extras, such as inquiring whether a user would like to make any further purchases. The information acquired may also be stored, such as in a database or sensor library, and analysed or compared to information acquired about other users of the ticket vending machine 100, in order to improve future user interactions and ticket vending transactions.

The derivation of information about the user may be performed in an appropriate order. For example, the sensor system 104 may detect first that a user is near the ticket vending machine 100, and then try to ascertain whether or the user is approaching the ticket vending machine 100. If the user is approaching the ticket vending machine, then the system may assume that the user intends to use the ticket vending machine 100 and accordingly additional information about the user, such as his/her height, may be derived. On the other hand, if it is determined that the user is not approaching the ticket vending machine 100, for example, if the user is walking away from the ticket vending machine 100, then it may be determined that the user does not intend to use the ticket vending machine 100 and no further action may be taken.

Note that an estimation of user height by ticket vending machine 100 may take into account depth (z) information, i.e. distance from the vending machine. This depth information, which can be provided by sensor units such as the Microsoft Kinect™ system, can help to distinguish between a smaller person who is relatively close to the machine, and a larger person who is relatively far from the machine.

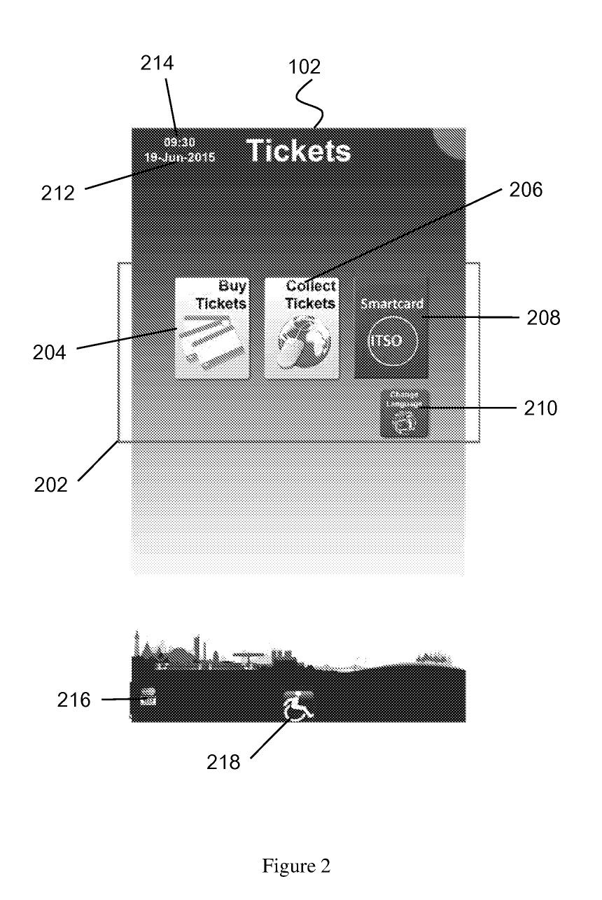

FIG. 2 illustrates an example of a display on the vertical touchscreen 102. The control system is configured to determine a portion 202 of the vertical touchscreen 102 which is active for touch input. For example, the active portion 202 of the vertical touchscreen may be a section of the vertical touchscreen 102 containing a graphic user interface, or one or more interaction targets for the user to interact with (e.g. touch) during the ticket vending transaction. The active portion 202 of the vertical touchscreen 102 may comprise a window, buttons, menus or a combination thereof, on the vertical touchscreen 102. Such elements provide a graphical user interface (GUI) that allows the user to provide touch input through the GUI during a ticket vending transaction. For example, the active portion 202 of the vertical touchscreen 102 may contain buttons which, when touched by the user, allow the user to buy a ticket 204, collect a pre-paid or pre-booked ticket 206, indicate that the user has a smartcard or contactless ticket 208, or allow the user to change the language of the information 210 on the vertical touchscreen 102, etc.

The control system may be configured to display other information on the vertical touchscreen 102 alongside the active portion 202 to assist the user, for example the date 212, the time 214 and information about the types of credit or debit card that the ticket vending machine accepts 216. In other words, other portions of the vertical touchscreen 102, besides the active portion, may be utilised for displaying information and control options to a user, and also for receiving touch input. However, the active portion 102 is generally utilised for the primary input/output interaction with the user, for example, with respect to the core application flow as a user operates the machine with respect to ticket vending.

The information acquired by the sensor system 104 may be used to derive an estimated height of user. For example, the height of the user may be estimated based on the size of object detected by the sensor system 104 and determined to be a person, or based on a number of facial features detected by facial detection/recognition. In response to the estimated or determined height of the user, the control system is configured to set a height of the active portion 202 of the vertical touchscreen 102 according to the height of the person derived from the acquired information about the person. (The height of the active portion represents its location within the vertical touchscreen in terms of its up/down positioning, i.e. parallel to the vertical axis).

The active portion 202 may be positioned within the vertical touchscreen 102 by the control system according to the height of one or more detected parts of the user's body. For example, the active portion 202 of the vertical touchscreen 102 may be positioned at the height of the user's chin, shoulders or elbow. The active portion 202 of the vertical touchscreen 102 may also be positioned a predetermined height below the detected height of the user's eyes, for example 0.3 m. This enables the active portion 202 of the vertical touchscreen 102 to be at a comfortable position both for reading and also for operating (by touching or pressing). The active portion 202 of the vertical touchscreen 102 may also be positioned a predetermined distance between the detected height of the user's eyes and the detected height of another part of the user's body, for example, his/her hand. This allows the active portion 202 of the vertical touchscreen 102 to be positioned at a height which is both easy to read and also comfortable for the user to interact with.

Having the vertical touchscreen 102 extend a relatively large distance in the vertical direction helps to accommodate a wider range of user heights. In addition, ticket vending machines 100 are generally subject to regulations regarding use by people with disabilities, for example, wheel-chair users, and supporting a wide range of user heights helps to comply with these regulations.

In some cases, the height of the active portion 202 of the vertical touchscreen 102 set by the control system may not be appropriate for a user. Accordingly, the ticket vending machine 100 may allow a user to manually adjust the height of the active portion 202 of the vertical touchscreen 102. For example, if an adult and a child approach the ticket vending machine 100 at the same time, the sensor system 104 may detect the child and the control system may set the height of the active portion 202 of the vertical touchscreen 102 according to the determined height of the child. However, the adult may then wish to adjust the height of the active portion 202 of the vertical touchscreen 102 to a more comfortable or convenient position for the adult's height.

The machine may allow a user to move the active portion 202 of the vertical touchscreen 102 to a desired height by touching the vertical touchscreen 102 at a point within the active portion 202 of the vertical touchscreen 102 and dragging active portion 202 of the vertical touchscreen 102 to the desired height. A plurality of adjustment buttons may also be provided, such as physical buttons adjacent to the vertical touchscreen 102, and/or buttons in the active portion of the vertical touchscreen 102 to allow the user to adjust the height of the screen further. For example, one button may be provided to move the active portion 202 of the vertical touchscreen 102 up and one button may be provided to move the active portion 202 of the vertical touchscreen 102 down. The control system may then configured to receive an input from the user, either by touching the vertical touchscreen 102 or by pressing a physical button, and then move the active portion 202 of the vertical touchscreen 102 vertically on the touchscreen in response to the desired height.

The screen shown in FIG. 2 also includes a button 218 located centrally at the bottom of the vertical touchscreen 102, which is provided for a user in a wheelchair to touch. In response to a user touching this button 218, the control system can set the active portion 202 of the vertical touchscreen 102 to a low height, for example at the bottom of the vertical touchscreen 102. This allows such a user to reduce the height of the active portion 202 of the vertical touchscreen 102 if it is initially set at too high a level, for example because the sensor system 104 has determined a height based on some other (taller) person in the vicinity. A physical button located below the vertical touchscreen may also be provided for the same purpose.

Note that the height positioning of the input buttons, relative to the height of a user, is generally more sensitive than the height positioning of information or other visual output. Thus information may be read from some distance (if presented in a suitably large format), when height then becomes less of issue. However, touch input is constrained by the physical length (and manoeuvrability) of a user's arm, and hence better height matching should be achieved. Accordingly, the control system may give primary weight to the position of the buttons or other user input facility based on the estimated height of a user (with the information output then being positioned at a suitable location having regard to the position of the buttons as already determined).

If a user is detected by the sensor system 104, but the machine is unable to estimate a reliable value of the height of the user, the control system may place the active portion 202 of the vertical touchscreen 102 at the mid-height of the vertical touchscreen. The user can then be allowed to adjust the height of the active portion 202 of the vertical touchscreen 102 to suit his or her preference using the means described above.

The control system may store, for example in a database or machine learning system, information about the estimated height of a user of the ticket vending machine 100, and the height of the active portion 202 of the vertical touchscreen 102 as used by that user, along with further information as to whether the height of the active portion was used as set by the machine, or whether the user manually (re)set the height of the active portion 202 of the vertical touchscreen 102. This stored information may then be used, in effect as a form of training system, for improving the estimation of the height at which to set the active portion 202 of the vertical touchscreen 102 for future users of the ticket vending machine 100. For example, if a large number of users adjust the height of the active portion 202 of the vertical touchscreen 102 to be lower than the height set by the control system, the control system may update the calculations it uses to determine the height at which to set the location of the active portion. Such updates may take various forms, including altering the relative weighting given to different pieces of derived information, such as total height, eye level, hand level, etc., and/or altering the distance of a user away from the ticket vending machine at which the height is estimated. For example, it may be found that height estimates lose reliability if a user is more than a distance of say 8 m away from the machine, so that the height estimates might be limited to users who are closer to vending machine than this distance. Adjusting and enhancing in this manner the height estimation procedure for the active portion 202 by ticket vending machine 102 can help to improve the user experience when using the ticket vending machine.

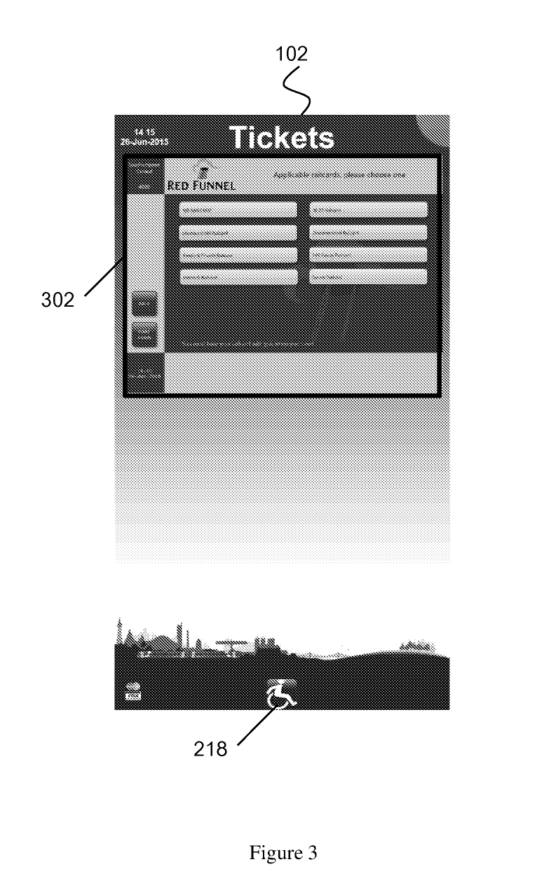

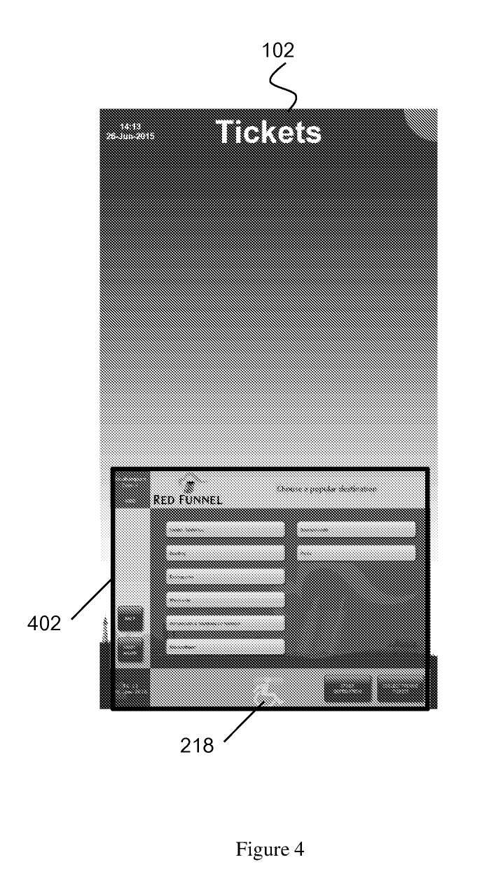

FIGS. 3 and 4 illustrate examples where the control system has detected the height of a user and set the height of the active portion of the vertical touchscreen 102 accordingly. In the example illustrated in FIG. 3, the active portion 302 of the vertical touchscreen 102 has been set towards the top of the vertical touchscreen 102. In the example illustrated in FIG. 4, the active portion 402 of the vertical touchscreen 102 has been set towards the bottom of the vertical touchscreen 102. The positioning shown in FIG. 4 may also arise if the user has pressed the button 218 in order to set the height of the active portion 402 according to the particular needs of that user, e.g. if the user is short or in a wheelchair.

Other information about the user may be derived based on the information acquired by the sensor system 104, and this additional information may likewise be used to tailor the user experience for the currently detected user of the ticket vending machine 100. For example, a determined age range of the one or more users of the ticket vending machine 100 may be used to offer or recommend particular services or tickets to the users. For example, if the derived age information indicates that a user is child or young adult (or is accompanied thereby), and then the ticket vending machine may display a recommendation or offer for a young person's ticket to the user in the active portion 202 of the vertical touchscreen 102. Similarly, if the derived age information indicates that a user is relatively old, then the ticket vending machine may display a recommendation or offer for a concession for such a person. A determined gender of a user of the ticket vending machine 100 may also be used to offer additional information or services to the user, e.g., once the ticket sales process has been completed. For example, information relating to the location of male or female toilets may be displayed on the active portion 202 of the vertical touchscreen 102.

The sensor unit 104 (and/or associated control system) may determine a number of users currently present in the vicinity of the ticket vending machine 100. This information may then be used to offer or recommend particular services or tickets to the users, or to offer additional products or information to the users once the sales process has been completed. For example, the ticket vending machine may be configured to display a recommendation or offer for a group ticket to the users if the number of users detected is greater than the minimum requirement for such a group ticket.

As mentioned above, if the sensor system 104 detects a relatively large number of people who seem to be waiting to use the ticket vending machine 100, such as when people are queuing for the machine, the ticket vending transaction process may be simplified and/or sped up in order to increase the throughput of users. For example, the vending machine may no longer display recommendations or additional information on the vertical touchscreen 102 in order to simplify the ticket vending transaction process.

The information acquired about one or more users of the ticket vending machine 100 may be used in combination in order to offer or recommend particular services or tickets to the users. For example, if four users of the machine are detected and the derived age information indicates that two of them are children or young adults, the control system may be configured to display a recommendation or offer for a family ticket to the users in the active portion 202 of the vertical touchscreen 102.

The information acquired about one or more users of the ticket vending machine 100 may help to assist with statistical analysis and data capture. For example, the number of users passing a ticket vending machine 100 in a given time period, along with their age, gender and height may be captured and used to determine the audience and effectiveness of a particularly advertisement being shown on the vertical touchscreen 102. The information acquired may also be used to estimate the footfall in a given station, shopping mall, car park or other location where a ticket vending machine 100 is located. The footfall may be compared to the number of ticket vending transactions carried out on the ticket vending machine 100 to provide a measure of effectiveness for the ticket vending machine 100. For example, it may be determined that one ticket vending machine 100 located in a particular part of a train station has a high footfall and a high number of ticket vending transactions whilst another ticket vending machine 100 located in a different part of the same train station has a relatively low footfall and number of ticket vending transactions. The owner of the station or the ticket vending machines 100 may then elect to move one or more machines to the location of high footfall.

The information acquired by the ticket vending machine 100 may also be used to tailor advertising such as might be shown on the vertical touchscreen 102. For example, if a person is detected near the ticket vending machine 100, but apparently not approaching the ticket vending machine 100 (so perhaps not a user), the control system may change an advertisement displayed on the vertical touchscreen 102 based on additional information about such person derived from the sensor system 104. For example, if a man is determined to be passing near the ticket vending machine 100, the vertical touchscreen 102 might be used to advertise a male toiletry product.

The ticket vending machine may also be configured to display a message on the vertical touchscreen 102 to inform a user if their presence has been detected, for example a welcome message. The control system may be configured to change the welcome message based on any additional information detected about the user, such as their gender, age, mood, etc.

Additionally, if an act of vandalism or crime is carried out on or in the vicinity of the ticket vending machine 100, information acquired by the sensor system 104 might be used to determine the criminals or any witnesses that may have been present.

The control system may also be configured to display an image or screensaver on the vertical touchscreen 102 when the ticket vending machine 100 is not in use. For example, a map showing the station or shopping mall in which the ticket vending machine 100 is located may be displayed when the sensor system 104 does not detect any people as currently near to the ticket vending machine 100. Alternatively, or on a different portion of the vertical touchscreen 102, an advertisement may be displayed when no users are detected by the sensor system 104 to be near the ticket vending machine 100. The control system may then stop displaying such an advertisement when the sensor system 104 detects a person to be near the ticket vending machine 100. The control system may also display the active portion 202 of the vertical touchscreen 102 and set the active portion 202 of the vertical touchscreen 102 at the mid-height of the vertical touchscreen 102 in response to a user touching the vertical touchscreen 102. Therefore, if the user is not detected by the sensor system 104, they are still able to use the ticket vending machine 100.

The control system may display additional information to the user on the vertical touchscreen 102 when the ticket vending machine 100 is not in use for a ticket vending transaction and/or immediately following a ticket vending transaction. For example, the ticket vending machine may display on the vertical touchscreen 102 a map of a station showing the location or platform/stand number that a user's train, bus or other form of transport is due to depart from and directions for how to get there. The control system may also display on the vertical touchscreen 102 arrival and departure information to inform the user whether their train, bus or other form of transport is on time, delayed or cancelled. The control system may display on the vertical touchscreen 102 a map of a station showing the location of a particular shop or facility that may be of interest to the user and directions for how to get there. When the ticket vending machine 100 has been used in conjunction with a mobile phone or personal electronic device, the control system may be configured to transmit such information to the mobile phone or personal electronic device via a wireless communication link, such as Bluetooth, NFC or Wi-Fi.

The ticket vending machine 100 may control the duration of time that the ticket vending machine 100 is able to provide additional information, such that the ticket vending machine 100 spends the majority of the time processing ticket vending transactions. This helps to prevent large queues forming at a ticket vending machine 100 and to ensure that users are able to carry out their ticket vending transactions in a timely fashion. The control system may utilise a timer such that the ticket vending machine 100 is only able to provide additional information for a fixed, short period of time, for example less than 5 minutes.

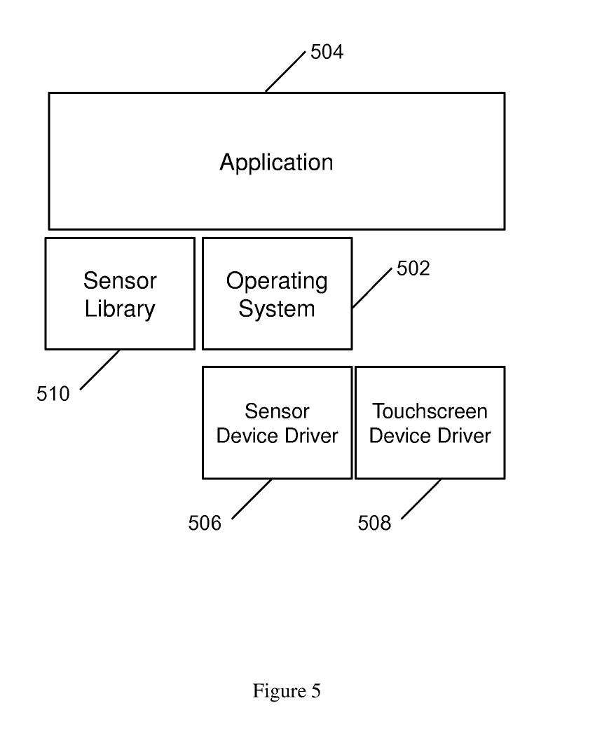

FIG. 5 shows a component diagram of a ticket vending machine 100 in accordance with various implementations. An operating system 502 is provided, which in turn supports a control application 504 running on ticket vending machine. The application 504 contains instructions which are communicated via the operating system 502 to a sensor device driver 506 to control the components of the sensor system 104. The application 504 also contains instructions which are communicated via the operating system 502 to a touchscreen device driver 508 to control the vertical touchscreen 102 and change the information displayed on it, such as the height of the active portion 202 of the vertical touchscreen 102. A sensor library 510 may also be provided containing data which can be compared to data acquired by the sensor system 104 to detect the presence of a person.

Other software components may also be present for use in conjunction with other hardware components that may form part of the ticket vending machine 100, such as a card payment machine 106, a contactless or NFC card reader 112 or a ticket printer.

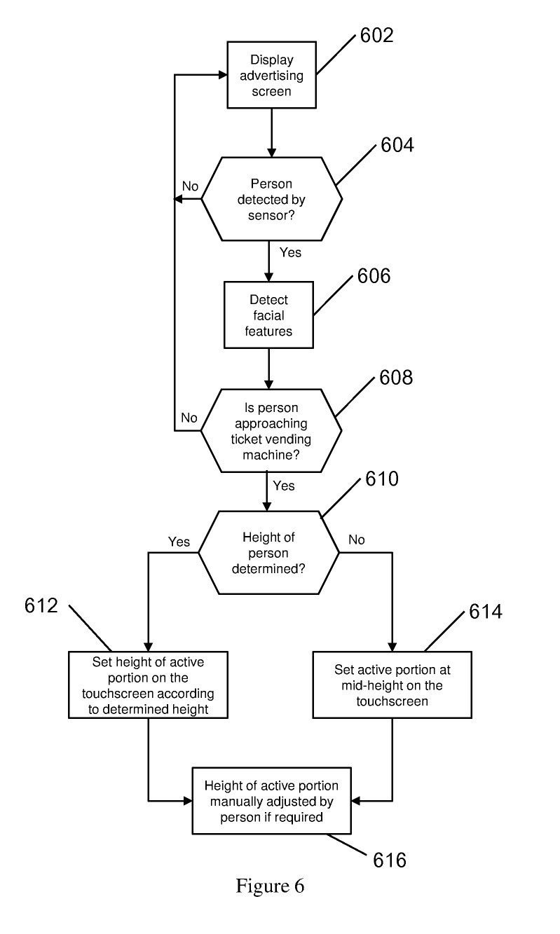

FIG. 6 shows flow diagram of a method for adjusting the height of the active portion 202 of the vertical touchscreen 102 on a ticket vending machine 100. At step 602, the control system is configured to display an advertisement on the vertical touchscreen 102. The advertisement may be a still image or a video or a combination thereof.

At step 604 it is determined whether a person or user is detected by the sensor system 104. If no person is detected by the sensor system 104, the method returns to step 602 and the control system continues to display an advertisement on the vertical touchscreen 102. If however a person is detected by the sensor system 104, the method continues to step 606.

At step 606 facial features of the person are detected. The method then continues to step 608 and additional information is derived to determine whether the person is approaching the ticket vending machine 100. If the person detected by the control system is determined not to be approaching the ticket vending machine 100, then it may be assumed that the person does not wish to use the ticket vending machine 100, and the method returns to step 602 where the control system continues to display an advertisement on the vertical touchscreen 102. However, if the person detected by the control system is determined to be approaching the ticket vending machine 100 then the method proceeds to step 610.

At step 610 method attempts to determine the height of the person. If the height of the person can be determined, the method continues to step 612 in which the height of the active portion 202 of the vertical touchscreen 102 is set according to the detected or estimated height of the user. If the height of the person cannot be determined, then the method continues to step 614, in which the height of the active portion 202 of the vertical touchscreen 102 is set to the mid-height of the vertical touchscreen 102 (or to some other suitable default value). A ticket vending transaction may then commence.

At step 616 the user is able to manually adjust the active portion 202 of the vertical touchscreen 102 if required during the ticket vending transaction. When the ticket vending transaction is finished, the method may re-start at step 602 again.

The ticket vending machine described herein may perform a number of software-controlled operations. In such cases, the software may run at least in part on special-purpose hardware (e.g. GPUs) or on conventional systems with conventional processors. The software may be loaded into such hardware, for example, by a wireless or wired communications link, or may be loaded by some other mechanism—e.g. from a hard disk drive, or a flash memory device.

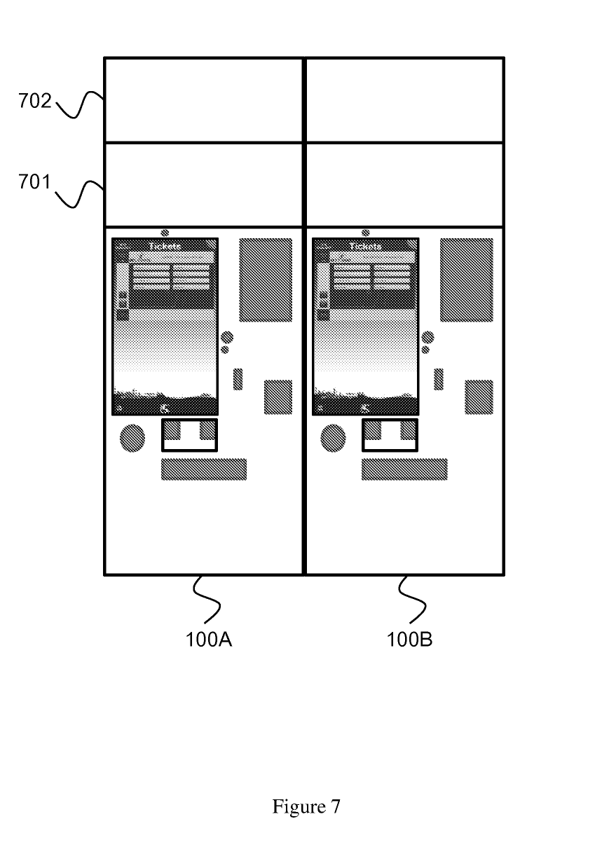

FIG. 7 illustrates an example of a system having multiple ticket vending machines 100A, 100B. Each of the ticket vending machines 100A, 100B is generally able to operate as a standalone ticket vending machine, as described above in relation to ticket vending machine 100. However, the function of ticket vending machines 100A, 100B has been supplemented to allow the set of multiple ticket vending machines to operate and be managed as a collective entity (rather than merely as just a set of multiple, essentially stand-alone, machines).

The multiple ticket vending machines 100 (such as machines 100A, 100B) are installed together in a shared physical location. The particular example shown in FIG. 7 has machines 100A, 100B immediately adjacent to one another and having a shared orientation. This is a common configuration, in which multiple machines may (for example) be installed against a wall, but other configurations are possible. For example, machines 100A, 100B might be located back-to-back in the concourse of a venue (station, shopping mall, etc). Such a configuration can help to improve visibility of the set of machines, since they are now facing in two different directions.

Moreover, the machines 100 do not have to be located immediately adjacent to one another, but are at different positions within a shared physical location. Such a shared physical location can be considered as a single venue, such as a railway station, in which the machines are operated together and generally perform substantially the same task. For example, the multiple ticket vending machines might be located at different entrances into a railway station, or adjacent different platforms, or on different floors of a car park, etc. Within the shared physical location, the multiple ticket vending machines are typically close enough to one another to allow a user to walk from one machine to another, thereby permitting interchangeability of use according to the circumstances.

It will be appreciated that these are just examples of installations with multiple ticket vending machines, and the skilled person will be aware of many more possibilities—e.g. from having just two machines, through to having a much larger number of machines (such as ten or twenty, or possibly more). Similarly, a given installation may adopt one or more of the configurations described above, with some machines sharing the same physical position and orientation, some machines sharing the same physical position but with different orientation, and some machines distributed at different physical positions across the shared location. Furthermore, the ticket vending machines within a given cluster may all be the same as one another, or there may be some differences between the various machines. For example, only some, but not all, of the ticket vending machines 100 may accept cash payment (the remainder perhaps just accepting credit card payments); likewise certain types of tickets might only be available from some, but not all, of the machines.

The ticket vending machines 100A, 1008 shown in FIG. 7 are provided with one or more screens 701, 702 above (or otherwise adjacent to) them, for displaying still images or video. Each screen 701, 702 is controlled by a corresponding ticket vending machine. When a plurality of ticket vending machines are located next to each other, such as shown in FIG. 7, the one more screens can be used in combination to form a video wall, which may display, for example, arrivals and departure information for trains, bus and other forms of transport, travel information or advertisements. Each screen may also show information about the operation and status of its associated ticket vending machine, for example, whether the ticket vending machine is currently operational, if only certain types of tickets are available from this machine, and/or if only certain types of payment are accepted (such as credit card but not cash).

Each ticket vending machine 100 is configured to monitor its current level of usage by acquiring current usage data from one or more sources. One such source of data is generally the rate of transactions being performed (or initiated) on the ticket vending machine, e.g. based on the rate of interaction with touchscreen 102, or other such indication of user interaction. A further potential source of information is the sensor system 104, which may be configured to detect the number of people near the ticket vending machine, e.g. based on facial detection. This additional data from the sensor system is useful because it provides an indication of a queue to use the machine; in other words, not only might a machine be have a high level of usage, but the current demand may, in fact, be greater than the capacity of the machine.

The determination of the current level of usage will generally be assessed over a predetermined period of time, for example, over a period of say the last 30 minutes, 20 minutes, 10 minutes, 5 minutes, two minutes or one minute. The monitored level of current usage may then be updated at regular intervals (which may or may not correspond to the predetermined time interval for assessing current usage). For example, a system may assess its current level of usage based on the number of ticket transactions initiated in the past 10 minutes, with this usage level being updated every minute.

The skilled person will be aware of many potential modifications of the above approach. For example, a higher weighting may be given to transactions at the end of the predetermined period of time, compared with at the beginning of this period, so that the usage is a better reflection of present workload for the machine. Likewise, the monitoring make track changes in usage of the machine, i.e. whether the workload is currently increasing, stable or decreasing, over time, by comparing the usage for the most recent predetermined time interval with a value obtained for a preceding time interval.

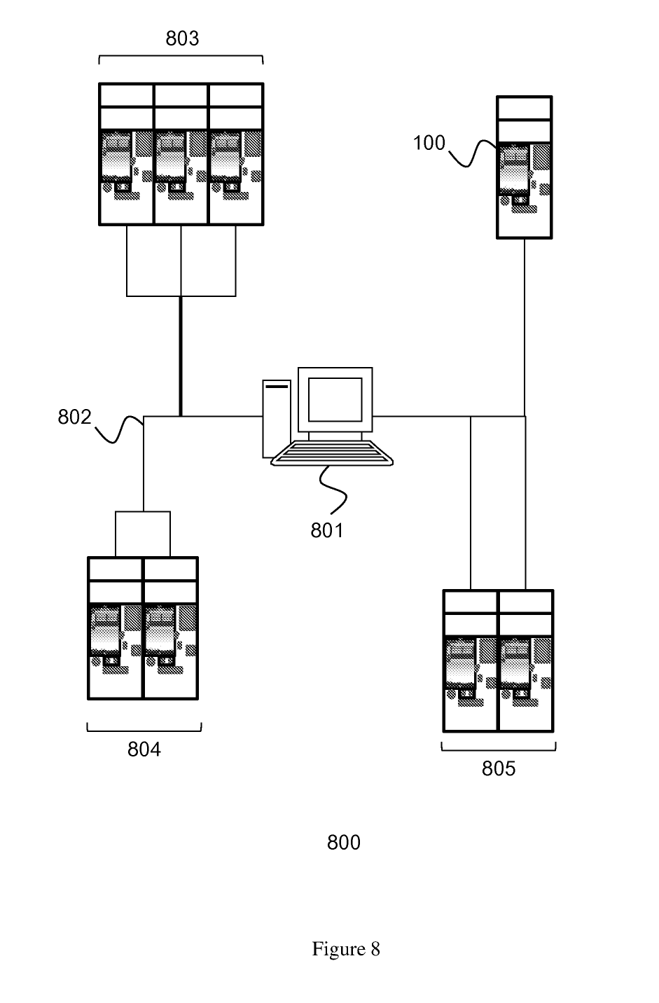

FIG. 8 illustrates a system 800 according to some embodiments of the invention, in which. a computer 801 is linked to a plurality of ticket vending machines 100 by one or more communications links 802. For example, the communications link 802 may be provided by a wired or wireless local area network (such as Ethernet, Wi-Fi, etc), or a combination thereof. Note that such a network may already be available at the venue, and can be readily supported by the ticket vending machines 100, which as described above, may be implemented on top of a conventional personal computer or similar. The computer 801 provides a control system for the overall set of ticket vending machines 100. In some implementations, this control system may be provided with a suitable backup facility to accommodate the possibility that computer 801 goes off-line.

As illustrated in FIG. 8, each ticket vending machine may be part of a group of ticket vending machines 803, 804, 805 or a single ticket vending 100 or combinations therefore. Furthermore, each group of ticket vending machines may contain a different number of ticket vending machines. The computer 801 may be hosted within one of the ticket vending machines 100, for example, sharing the personal computer used to implement the ticket vending machine, or using additional hardware located in such a ticket vending machine. Alternatively, the computer 801 may be separate from the ticket vending machine. In some cases, the computer 801 may be located at the venue itself, for example in some control room; alternatively, the computer 801 may be located remote from the venue, at some other site, and accessed over the Internet or other long-distance communication facility.

In practice, there can be different levels of activity at the different ticket vending machines. For example, ticket vending machine at an entrance near a bus stop might be busy if a bus has just arrived, but quieter if a there has been no bus for a while. As another example, a large party may congregate around one or more machines, making them very busy, but leaving other machines under-utilised. The system of FIG. 8 is intended to provide coordinated management of such a set of individual ticket vending machines 803-805 which may, for example, experience significant relative variations in terms of how busy they are.

The computer 801 is configured to collect the usage data from each ticket vending machine 100 in the plurality of ticket vending machines over communications links 802. There are a number of ways in which this communication may be regulated. For example, each ticket vending machine may, on its own initiative, send the usage data to the computer system 801 at regular time intervals, say every 10 minutes, or every 5 or 2 minutes. Note that the interval of these transmissions might be altered (either by the ticket vending machine 100 itself, or at the request of the computer system 801), according to circumstances—e.g. in a busy period the computer system 801 may want more frequent updates. In addition, the ticket vending machine may send the usage data in response to a predetermined event—e.g. the usage level of the ticket vending machine rising about some predetermined threshold, or if a sudden increase in usage level occurs at the ticket vending machine. Similarly, the computer system 801 may request the ticket vending machine to send the usage data. Again, such a request might be sent at predetermined time intervals (say every 10, 5 or 2 minutes), or in response to specific events. For example, if the computer system 801 detects that one of the multiple ticket vending machines 100 is very busy, it may send requests to find out the current usage level of the other machines. It will be appreciated that a given system may support one or more of the above approaches, for example, the computer system 801 may generally poll the ticket vending machines at regular intervals, but an individual ticket vending machine may send the computer system an update if a given usage level is passed for that machine.

The exact nature of the usage data reported from a ticket vending machine to the computer system 801 may also vary from one embodiment to another. For example, in some cases, a ticket may transmit in effect the raw data (number of transactions, number of people queuing, etc), while in other cases, it may only send a summary or distillation of the usage data acquired by the ticket vending machine—e.g. an estimate of its current workload as a percentage of its maximum possible workload. The usage information may also include details regarding the nature of transactions (whether a new ticket purchase, or a collection of a pre-paid ticket; whether a cash transaction, or using a credit card or contactless). The ticket vending machine may just send information regarding its current usage level, or it may include information about the rate of change of such usage. The number of people queuing for the machine may also represent valuable usage information for the computer system, since it indicates the desired workload for the machine. The computer system may be able to request additional or more specific information from the vending machine if so required.

The computer 801 is configured to analyse the data received from the various ticket vending machines to ascertain whether one or more of the ticket vending machines 100 is experiencing a high level of usage. A high level of usage may be determined based on the number of people proximate to a ticket vending machine at a given time (such as detected by sensor system 104), the number of ticket transactions that have occurred in a given period of time, etc. The computer 801 is then configured to determine whether any actions should be performed by the set of ticket vending machines as a whole in order to reduce or mitigate this high level of usage. This determination typically involves comparing the usage level of the machine experiencing high usage with the usage level of other machines in the set of ticket vending machines (which may first require the computer 801 to send a request for up-to-date usage information from these other machines, if such information is not already available at the computer system). If the computer system 801 determines one or more vending machines should perform certain actions, it sends appropriate control instructions to the one or more of the ticket vending machines, which then implement the requested action.

The overall vending system can perform a variety of actions to try to mitigate the high usage level found at one or more machines. The computer 801 can select which action or actions should be performed by which machine or machines according to the current circumstances (e.g. how many, and which, ticket vending machines are currently experiencing high usage).

One example of an action to be performed is to change the display on the vertical touchscreen 102, additional screen 116, and/or video screens 701, 702 of one or more ticket vending machines 100. In particular, the computer system would send instructions to the relevant ticket vending machine(s) to make the desired changes, and these instructions would then be implemented accordingly. For example, if one or more machines are experiencing a high level of usage (including potential queuing) whilst one or more other ticket vending machines have a lower workload, and hence have spare capacity (or at least, a shorter queue), control instruction may be sent to the ticket vending machines experiencing a high level of usage to instruct those ticket vending machines to display appropriate information, e.g. on signage 701, 702. This information may inform a person waiting to use this ticket vending machine that another ticket vending machine may have shorter wait (or no wait). This allows people who are queuing to use a ticket vending machine to locate ticket vending machines with a lower level of usage, thus helping to alleviate queues and reducing the amount of time people have to wait to use a ticket vending machine—in effect, helping to maximise the efficiency of the overall set of ticket vending machines as a whole.

Note that providing such information about relatively under-used machines may be particularly useful in situations where people queuing to use one ticket vending machine cannot see other ticket vending machines that might have a shorter queue, for example if the set of ticket vending machines are proximate to each other but not facing the same direction (e.g. placed back to back), or if the ticket vending machines are further apart, such as adjacent different platforms. In these circumstances, it may also be helpful for the information displayed by the high usage ticket vending machine(s) to help a customer find a lower usage ticket vending machine—e.g. by displaying a map of its position, or directions (or an arrow) indicating how to find the lower usage machine.

In some cases, computer 801 may change a mode of operation of one or more ticket vending machines in order to address a current high level of usage for at least one machine within the set of ticket vending machines. The computer 801 will therefore send appropriate control instructions to each of the relevant ticket vending machines whose mode of operation is to be changed, and the ticket vending machine is configured to change its mode of operation in response to this control instruction. Note that this change of operational mode may occur instead of or in addition to providing customer information, as described above.

An example of a change of mode is where in normal operation, a ticket vending machine can be utilised to purchase new tickets, or to collect prepaid tickets. Typically, the latter transactions, in which a user is only collecting one or more prepaid tickets, are faster and take less time than the former transactions, in which a user is buying tickets or planning a journey, as there are fewer user selections and interactions steps in the process. Accordingly, if a high level of level of usage has been detected, one or more of the ticket vending machine may be sent control instructions to change their mode of operation so that they now only perform transactions relating to the collection of pre-paid tickets (but not purchase of new tickets). This allows a user wishing to collect pre-paid tickets to do so from what is now a dedicated ticket collection machine, for which relatively fast turnover can be expected, thereby helping such a user to avoid queues caused by a people performing longer transaction to buy new tickets. Note that in this example, the remaining machines may continue in their normal mode of operation, supporting both new ticket purchase and pre-paid ticket collection, or may be switched to being for new ticket purchase only (or some split between the two) depending upon the particular circumstances, such as the overall number and configuration of machines. Additionally, the control instructions may instruct ticket vending machines to change the display on the vertical touchscreen 102 and/or signage 701, 702 proximate to each ticket vending machine 100 to inform the users which services are available at each ticket vending machine to assist users in determining which ticket vending machine they should use for their transaction. (This change in display may be inherent in the change of mode of operation, rather than being explicitly instructed by the computer 801 by a separate control instruction). Switching to this configuration of machines may be particularly helpful if the current usage data indicates a higher level than usual of collection of pre-paid tickets (or if this might be expected shortly for other reasons, such as past patterns of usage data).

Various other examples of potential changes in mode of operation that may be instructed for some or all vending machines are:
(a) to change their mode of operation to perform only essential operations relating to ticket transactions. For example, the ticket vending machines may be instructed not to display advertisements during transactions, and/or not to offer additional services to the users—e.g. in a railway station, the ticket vending machine may not offer tickets for events at the planned travel destination, or offer information about potential hotels at this destination. This may save time on some transactions, and hence help to increase the rate of transactions for that ticket vending machine.
(b) to limit the type of tickets that they offer. For example, some ticket vending machines might be limited to tickets for the current travel day, or for tickets to a particular subset of popular destinations. By limiting the options available to a user on such machines, the menu structure can be simplified and compacted, which again can help to save time on transactions.
(c) to restrict the payment method(s) supported by a ticket vending machine, for example, to just credit/debit card or contactless, since such payment mechanism may again save time (compared with cash payment).
(d) to change their mode into a low power or standby mode if the set of machines as a whole is currently experiencing low overall levels of usage. This can help to conserve power and electricity. This is particularly suited to a bank of adjacent machines, so that the existence of alternative machines which are available for operation is readily apparent to a user.
   It will be appreciated that these are just examples of how a ticket vending machine could be change to have different modes operations. These examples are generally not mutually exclusive, but may be combined as appropriate (nor are they intended to be exhaustive). Moreover, as discussed above, screens 701, 702 or any other appropriate facility may be used to provide a user with information about the current mode of operation of the machine.

In some systems, the current usage data collected from the ticket vending machines may be utilised for determining other actions, beyond sending appropriate control instructions to the ticket vending machines. For example, if there is currently a high level of usage, the control system may request that more staff are deployed to assist any users who might be having difficulty with their transaction, e.g. by sending an SMS or email to such staff, or making an automated announcement over a loudspeaker (public address) system. If the support staff are physically present at the venue, they may be remotely accessible, such as over additional video screen 116. In addition, the current usage information may include supplementary information about the people currently proximate to the ticket vending machines, such as their ages, gender and facial expressions (this information may be provided by sensor system 104). The computer 801 may then be able to determine the mood of the people queueing to use a ticket vending machine; if there are a large number of people queuing to use one or more ticket vending machines and the majority of them look unhappy, the computer 801 may again to indicate that staff assistance may be required at one or more of the ticket vending machines.

The computer 801 may incorporate other information into its analysis of the usage data (in addition to the usage data itself). Thus certain usage patterns may be known or predictable—whether from historical patterns of usage data (such as previous usage data stored and accumulated at the computer), or from any other relevant source. These patterns of usage of the ticket vending machines generally reflect the time of day (e.g. peak commuting periods or not), day of the week (e.g. weekend or weekday), school holidays, major events (football matches, concerts etc). This information can help the computer (for example) to predict a period of high usage (even if such high usage has not yet been detected in the current usage information received from the machines, or is only moderately present) and then to take appropriate action(s), such as described above, on a pre-emptive or precautionary basis.

For example, a high number of ticket purchases to a particular destination may occur on a weekday morning to coincide with a morning commute period. A relatively high number of pre-paid tickets may be collected later in the morning or at midday coinciding with people attempting to avoid peak travel periods or take advantage of off-peak or specially discounted fares. A high number of season ticket purchases may occur at the start of the month to coincide with people renewing monthly season tickets. Such patterns of usage may be used by the computer 801 when determining whether the data relates to a high level of usage, a suitable action to be performed, and the relevant control instructions to be sent to one or more ticket vending machines in anticipation of the high usage. For example, the computer 801 may instruct certain ticket vending machines to change their mode of operation to perform only transactions relating to collection of pre-paid tickets in anticipation of an expected period of known high demand for such pre-paid tickets.

The determined usage patterns may also be used to help determine the effectiveness of location of each ticket vending machine. For example, if over a period of time a ticket vending machine or group of ticket vending machines see substantially higher usage than another ticket vending machine or group of ticket vending machines, consideration might be given to re-locating the latter ticket vending machines, e.g. to the location where higher usage is observed.

In some embodiments, a ticket vending machine 100 may also include a Bluetooth Low Energy (BTLE) beacon to assist with monitoring current levels of usage. The BTLE beacon may, for example, be a standalone unit within the ticket vending machine, or located outside the vending machine itself, but connected to the ticket vending machine, for example, via a USB link. The BTLE beacon can be configured to transmit an identifier which is received by nearby electronic devices, for example smartphones and tablets. The electronic device may then communicate with the beacon, which can allow the beacon (or a computer system connected thereto) to derive some positional information for the electronic device. The beacon may also be able to recognise the electronic device from identification information provided by the electronic device.

In some implementations, the information obtain by the beacon (e.g. position and/or identity) may be sent to the computer 801 as part of the current usage information. In some cases this information will be transmitted directly from the beacon to the computer 801, in other cases the information will first go from the beacon to the associated ticket vending machine for transmission to the computer 801. Other approaches are also possible. For example, an app on the electronic device itself may acquire the relevant information from the beacon, and transmit this to the computer 801 (typically via some appropriate network path). If the electronic device is within range of a plurality of beacons, for example located within a plurality of respective ticket vending machines, the information from each of the beacons may be used in combination to triangulate the position of the electronic device in relation to the beacon positions (and hence the ticket vending machines). Such information about current usage obtained by the computer 801 using the beacon(s) can then contribute to the analysis for determining whether any control action should be taken.

One possibility is that if the computer is aware of the identity of a user approaching a given ticket vending machine (such as might have been obtained via the beacon(s)), then the ticket vending machine may be instructed to provide a customised service for that particular user. For example, the ticket vending machine may display a personalised welcome message on the vertical touchscreen 102, as well as customising the user menu based on stored data about previous transactions for that user and electronic device. For example, if the user regularly buys a certain type of ticket to a given destination, this option may be made directly available on a first screen of the interface on screen 102. Furthermore, if the user has purchased a pre-paid ticket via an app on the electronic device, the ticket vending machine may begin to print the ticket directly for the user without requiring the user to input further identifying information. This sort of personalisation can help the user to feel like a more valued customer, as well as allowing them to obtain their desired ticket more quickly, and so increase the rate of transactions for the ticket vending machine.

Once the computer 801 has determined an action to be performed and send appropriate control instructions to the ticket vending machines, the computer 801 will generally continue to receive and analyse current usage data. The computer 801 is then able analyse the effect the action has had on the level of usage of each ticket vending machine and to determine whether additional actions are required. For example, if the level of usage of the ticket vending machines has remained high, the computer 801 may determine that further action is required. Conversely, if a high level of usage has now abated, the computer 801 may determine to restore the set of the ticket vending machines to their previous state, i.e. before the high level of usage. For example, there may no longer be a need to limit one or more ticket vending machines to performing transactions relating to collection of pre-paid tickets, or only accepting contactless payment methods. The computer 801 may then send appropriate control instructions to the relevant ticket vending machines to implement such changes.

The overall system described herein therefore provides an automated and real-time control facility for a set of multiple ticket vending machines at a given venue. In this context, real-time implies a response time of typically no more than a few minutes at most (e.g. because longer queuing times might cause significant problems for users having to catch particular trains). Indeed, given that a queue can form very quickly, e.g. if a bus-load of passengers suddenly arrives at a station, then the response time of the control system could well be quicker, perhaps just 1 or 2 minutes or less.

These shorter timescales may also be helpful to avoid instabilities (in the sense of general control theory), such as where users are directed from a first ticket vending machine, which is currently busy, to a second ticket vending machine, which then becomes busy, so that users then have to be directed back to the first machine (and so on). One way to help address such issues is to take smaller actions (in terms of impact), but more rapidly. Also, as noted above, the computer is able to monitor the current usage levels on an ongoing basis, thereby providing a feedback loop to ensure that the control system is performing in an effective and efficient manner.

Overall, it will be appreciated that there are various important benefits arising from the ability to manage a set of ticket vending machines as a coherent group. For example, the computer 801 can make a more reliable detection of whether the set of machines as a whole is busy (compared to say, a situation where a large party all want to use just one machine in succession), or conversely if the set of machines as a whole is quiet (so that maybe one or more machines might be placed into a power-saving mode). Furthermore, the computer 801 is also able to perform more sophisticated management of resources, e.g. to help accommodate periods of high usage, such as by allocating specific ticket vending machines to particular tasks, and/or by helping to spread users across multiple different machines, thereby trying to make the best use of the available resources.

The skilled person will appreciate that these embodiments are provided only by way of example, and different features from different embodiments can be combined as appropriate. Accordingly, the scope of the presently claimed invention is to be defined by the appended claims and their equivalents.

1-36. (canceled)

37. An automated ticket vending system comprising multiple individual ticket vending machines in a shared physical location, a control system, and a communications facility for supporting communications between the individual ticket vending machines and the control system, wherein:
each ticket vending machine is configured to acquire data relating to the current level of usage of that ticket vending machine, and to transmit the acquired usage data to the control system;
the control system is configured to receive and analyse the usage data from the multiple ticket vending machines, and responsive to such analysis of the usage data, transmit control instructions to the multiple individual ticket vending machines specifying appropriate actions to address the current level of usage of the multiple individual ticket vending machines within the automated ticket vending system as a whole; and
each ticket vending machine is configured to perform the actions specified in the control instructions received from the control system.

38. The system of claim 37, wherein one of more of the ticket vending machines acquires data relating to the current level of usage of that ticket vending machine based on user transactions with the ticket vending machine.

39. The system of claim 37, wherein one of more of the ticket vending machines acquires data relating to the current level of usage of that ticket vending machine from a sensor system.

40. The system of claim 39, wherein the sensor system utilises imaging information.

41. The system of claim 37, wherein the ticket vending machine acquires data relating to the current level of usage of the ticket vending machine by using at least one beacon which interacts with an electronic device carried by the user over a wireless network.

42. The system of claim 41, wherein the acquired usage data includes an identifier of the electronic device or the user thereof which is used to personalise the interaction of the user with the ticket vending machine.

43. The system of claim 39, wherein the acquired usage data includes information about the number of people queuing for the ticket vending machine.

44. The system of claim 37, wherein the ticket vending machine filters or processes the acquired usage data before transmitting to the control system.

45. The system of claim 37, wherein a control instruction specifies a change in operating mode of the ticket vending machine receiving the control instruction.

46. The system of claim 45, wherein the change of operating mode may restrict the user functionality of the ticket vending machine to certain predefined tasks.

47. The system of claim 46, wherein the change of operating mode restricts a user to collection of pre-paid tickets from that ticket vending machine, but does not allow the user to purchase a new ticket from that ticket vending machine.

48. The system of claim 46, wherein the change of operating mode removes user options or information which are only ancillary to ticket purchase.

49. The system of claim 45, wherein the change of operating mode places the ticket vending machine into an energy saving mode if the overall current usage of the automated ticket vending system is low.

50. The system of claim 37, wherein a control instruction specifies information to be displayed on a screen which is part of, or associated with, the ticket vending machine.

51. The system of claim 50, wherein the displayed information is displayed for a ticket vending machine having a high current usage, and directs a user to another ticket vending machine having a lower usage.

52. The system of claim 37, wherein the control system is housed within one of the plurality of the ticket vending machines.

53. A ticket vending machine for use in an automated ticket vending system, wherein the ticket vending machine comprises a communications interface for supporting communications with the control system, and wherein the ticket vending machine is configured to: acquire data relating to the current level of usage of that ticket vending machine; to transmit the acquired usage data to the control system; and to perform actions specified in control instructions received from the control system.

54. A method for operating an automated ticket vending system comprising multiple individual ticket vending machines in a shared physical location, a control system, and a communications facility for supporting communications between the individual ticket vending machines and the control unit, the method comprising:
each ticket vending machine acquiring data relating to the current level of usage of that ticket vending machine, and transmitting the acquired usage data to the control system;
the control system receiving and analysing the usage data from the multiple ticket vending machines, and responsive to such analysis of the usage data, transmitting the control instructions to the multiple individual ticket vending machines specifying appropriate actions to address the current level of usage of the multiple individual ticket vending machines within the automated ticket vending system as a whole; and
each ticket vending machine performing the actions specified in the control instructions received from the control system.

55. A ticket vending machine comprising:
a vertical touchscreen;
a sensor system for acquiring information about a user; and
a control system configured to define an active portion within the vertical touchscreen, wherein the user is able to interact with the vertical touchscreen by touching the active portion,
and wherein the control system is further configured to set the height of the active portion within the vertical touchscreen according to the height of the user as derived from the information acquired by the sensor system about the user.

56. The ticket vending machine of claim 55, wherein the sensor system acquires two or three-dimensional imaging information.

57. The ticket vending machine of claim 56, wherein the sensor system and/or the control system is configured to perform a face detection analysis of the image information.

58. The ticket vending machine of claim 55, wherein the sensor system detects if a user is approaching towards the ticket vending machine.

59. The ticket vending machine of claims 55, wherein the machine is configured to estimate the approximate age of the user and/or the gender of the user based on the information acquired by the sensor system.

60. The ticket vending machine of claim 55, wherein the effective field of view of the sensor system excludes people who are not substantially in front of the ticket vending machine.
